(19) United States
(12) Patent Application Publication
(10) Pub. No.: US 2025/0321562 A1
(43) Pub. Date: Oct. 16, 2025

(54) THREE-DIMENSIONAL HIGH-PRECISION FIXED-POINT PRINTING METHOD AND DEVICE

(71) Applicant: SHANGHAI MEINAIER TECHNOLOGY CO., LTD., Shanghai (CN)

(72) Inventors: Yong XIANG, Shanghai (CN); Tengxi QIU, Shanghai (CN)

(21) Appl. No.: 19/248,705

(22) Filed: Jun. 25, 2025

Related U.S. Application Data
(63) Continuation of application No. PCT/CN2023/138261, filed on Dec. 12, 2023.

(30) Foreign Application Priority Data
Dec. 29, 2022 (CN) 202211726062.1

(51) Int. Cl. G05B 19/4063; B29C 64/112; B29C 64/386; B33Y 50/00; G06T 7/00; G06T 7/60; G06T 7/80

(52) U.S. Cl. CPC G05B 19/4063; B29C 64/386; B33Y 50/00; G06T 7/001; G06T 7/60; G06T 7/80; B29C 64/112; G05B 2219/49023; G06T 2207/10028; G06T 2207/30144

(57) ABSTRACT

A three-dimensional high-precision fixed-point printing method, including: printing, by a printer, a designated calibration pattern to a printing platform; obtaining, by photographing with a 3D camera, a two-dimensional picture and a 3D point cloud; and obtaining a conversion matrix between a printer coordinate system and a camera coordinate system at least based on the two-dimensional picture and the 3D point cloud, where the conversion matrix is regarded as external parameters of the 3D camera.

### CROSS-REFERENCE TO RELATED APPLICATION

The present application is a U.S. Continuation of International Application PCT/CN2023/138261 filed on Dec. 12, 2023, which claims the benefit of and priority to Chinese patent application No. 202211726062.1 filed with China National Intellectual Property Administration on Dec. 29, 2022, the content of the aforementioned applications is incorporated herein by reference in their entireties.

### TECHNICAL FIELD

The present application relates to the field of three-dimensional printing technologies, particularly to a three-dimensional high-precision fixed-point printing method and device.

### BACKGROUND

Traditional printers can achieve high positioning accuracy in their own printing coordinate system, but cannot print accurately in the world coordinate system. The reason for this lies in the positioning principle of printing.

### SUMMARY

In order to solve the above technical problems, the invention provides a three-dimensional high-precision fixed-point printing method. Firstly, a set of computer vision system is installed above the printing system, and at the same time, a set of special mark points is arranged on the top of the printing carriage for assisting the 3D camera to position the printing carriage. In order to unify the whole system coordinate system, a 3D camera coordinate system is introduced. The relationship between the three coordinate systems is that the 3D camera coordinate system includes the operating range coordinate system of the printer; The operating range coordinate system of the printer includes a printing target coordinate system, and the method is executed by the printer, where the method includes the following steps:
step S1, printing, by a printer, a designated calibration pattern to a printing platform;
step S2. obtaining, by photographing with a 3D camera, a two-dimensional picture and a 3D point cloud;
step S3, obtaining a conversion matrix between a printer coordinate system and a camera coordinate system at least based on the two-dimensional picture and the 3D point cloud.

Preferably, the step S1 includes:
step S11, placing calibration paper for the printer;
step S12, moving to and stopping at a mechanical starting position by the printer;
step S13, photographing by the 3D camera, and identifying a position T1 of a carriage in a 3D coordinate system through mark points on a top of a printing carriage, where the T1 is a printing starting position;
step S14, printing specific patterns by the printer.

The step S2 includes:
step S21, photographing by the 3D camera to identify a geometric center and a point cloud of pixel points of each printed pattern;
step S22, determining coordinates of each pattern in the camera coordinate system based on the identified geometric center and the identified point cloud of pixel points of each pattern;
the step S3 includes:
step S31, determining the conversion matrix between the printer coordinate system and the camera coordinate system based on coordinates of each pattern in the printer coordinate system and the camera coordinate system.

Preferably, before the step S11, the method further includes:
step S01, moving to and stopping at a printing starting position by a printing carriage;
step S02, photographing by the 3D camera, and identifying a position nT1 of a carriage in a 3D coordinate system through mark points on a top of a printing carriage;
step S03, comparing a coordinate of nT1 with a coordinate of T1 recorded in a factory calibration, to determine whether a difference between the two exceeds a threshold;
step S041, performing maintenance actions when the difference between the two exceeds the threshold.

Preferably, the maintenance actions include resetting a position of the printing carriage.

Preferably, the method further includes:
step S042, performing the steps S01 to S03 again after performing the maintenance actions, and marking the printer as a failure state when the difference between nT1 and T1 is still larger than the threshold.

Preferably, the method further includes:
step S042, performing the steps S11 to S14, S21, S22 and S31 when the difference between nT1 and T1 is less than the threshold.

Preferably, the printer has 3 freedom degrees to move in an X-axis, a Y-axis and a Z-axis, and a plane of the printing platform is parallel to a plane of nozzles of an ink-jet printer.

Preferably, the calibration pattern in the step S1 includes a checkerboard or a lattice diagram.

Preferably, in the step S2, the printing is performed by the printer when a z-axis coordinate is 0, and a starting position coordinate (x=0, y=0, z=0) of the printer is regarded as an origin of the printer coordinate system.

A three-dimensional high-precision fixed-point printing device, where a printing mechanism in the printing device performs printing through coordinate parameters provided by a computer vision mechanism, and includes a rack, installed with the computer vision mechanism, a hand slot mechanism and a printing mechanism, where the computer vision mechanism is arranged directly above the hand slot mechanism.

Preferably, the computer vision mechanism includes a camera, a structured light component, a vision control module, a light filling component and a moving module.

Preferably, the printing mechanism is connected with an X-axis moving module, a Y-axis moving module, and a Z-axis moving module, and the printing mechanism moves in an X-axis direction, a Y-axis direction, and a Z-axis direction.

Preferably, the X-axis moving module includes a driving motor, where the driving motor is connected to a driving wheel, the driving wheel is connected to a driven wheel through a transmission belt, and the driven wheel is installed at another end of the rack.

Preferably, an ink absorbing assembly is installed on the rack below the printing mechanism, and the ink absorbing assembly includes an ink absorbing sponge and a sponge holder, where the sponge holder is fixed to the rack.

Preferably, an ink receiving box is installed on one side of the ink absorbing assembly, an opening is provided at an upper part of the ink receiving box, and a through hole is provided at a bottom part of the ink receiving box.

Technical effects and advantages of the present invention are as follows.

According to the printing requirements of the user, the 3D coordinates are converted to the printer coordinate system, so as to accurately print to the target position, and the pattern can be flexibly printed on the object to be printed according to the actual position of the object to be printed, without manual measurement and adjustment, which greatly improves the speed and accuracy. Through self-check and optional recalibration, damage to the user due to positioning errors caused by various reasons during nail decorating can be effectively avoided. When there is a positioning failure occurred to the printer, it can be found by the machine through automatic check, thereby preventing the machine from operating in a faulty state and causing losses.

### BRIEF DESCRIPTION OF THE DRAWINGS

FIG. 1 is a schematic diagram of a structure of the calibration in the three-dimensional high-precision fixed-point printing method according to embodiments of the present invention;

FIG. 2 is a schematic structural diagram of a three-dimensional high-precision fixed-point printing device according to embodiments of the present invention.

FIG. 3 is an enlarged structural diagram of portion A in FIG. 2 of the three-dimensional high-precision fixed-point printing device according to embodiments of the present invention.

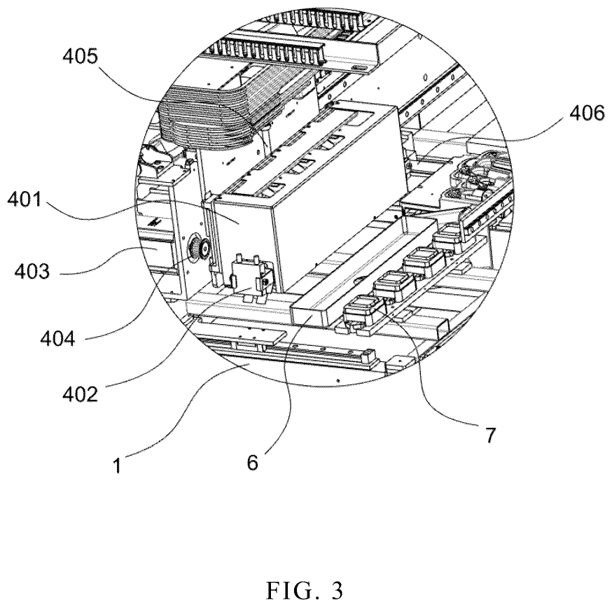

In the FIGS.: 1, rack; 2, computer vision mechanism; 3, hand slot mechanism; 4, printing mechanism; 401, printing nozzle module; 402, soft sensor; 403, driving motor; 404, driving wheel; 405, Y-axis moving module; 406, Z-axis moving module; 5, driven wheel; 6, ink receiving box; 7, ink absorbing assembly.

### DETAILED DESCRIPTION

Attached drawings and specific embodiments are combined as follows to further describe the present disclosure. The embodiments of the present invention are presented for the sake of example and description, and are not intended to be exhaustive or to limit the invention to the disclosed modes. Many modifications and variations will be apparent to those of ordinary skill in the art. The embodiments have been selected and described in order to better illustrate the principles and practical applications of the invention and to enable those of ordinary skill in the art to understand the invention so as to design various embodiments with various modifications suitable for particular applications.

Two coordinate systems that determine the real printing position include the operating range coordinate system of the printer and the coordinate system of a printing target.

The operating range coordinate system of the printer includes the mechanical starting position of the printer (x0, y0, z0) to (xMax, yMax, zMax). Under the same operating condition, the printer can achieve high-precision repeated positioning in its own coordinate system. However, the positioning errors of the X-axis, Y-axis and Z-axis will occur after operating for a long time, which may be caused by mechanical wear, aging and fouling of positioning devices, etc. For example, positioning errors are likely to occur to gratings often used for X-axis positioning in the industry due to defacement, flying ink, dust and other reasons. In this case, the operating range coordinate system of the printer is changed, resulting printing positioning errors and failing to operate normally.

The coordinate system of the printing target refers to the coordinate system of the item itself to be printed. Take an A4 sheet of paper as an example, starting from the upper left corner (x0, y0) (the z-axis is fixed, which is not discussed herein) to the lower right corner (xMax, yMax). The coordinate system of the printing target and the operating range coordinate system of the printer are obviously not the same coordinate system. In the traditional printing system, the coordinate system of the printing target does not exist or is completely consistent with the operating range coordinate system of the printer by default. The positioning and typesetting of the traditional printing data are completely determined according to the operating range coordinate system of the printer. Therefore, in actual operation, we always use some auxiliary positioning marks to place paper to ensure the relative correctness of the printing position. The accuracy of this kind of printing position is very low, which depends on the coincidence of the two coordinate systems when placing the printing target (paper). The higher the coincidence, the more accurate the position.

Through the above, it can be seen that the problems in the positioning of traditional printing systems are as follows.

It is difficult for a printer to print the same pattern on the same position of different printing targets.

When there is a hardware problem with the printer that leads to a positioning failure, it will directly lead to a printing error.

The above problems are acceptable to a certain extent in traditional printing scenarios, but they become fatal problems in nail decorating scenarios. At any time, the user cannot accept that the nail decorating effect is printed to places other than nails. This requires extremely high positioning accuracy of the printing system in the world coordinate system.

Therefore, an object of the present application is to provide a three-dimensional high-precision fixed-point printing method and device, aiming to improve the problem that traditional printers cannot achieve precise printing in the world coordinate system.

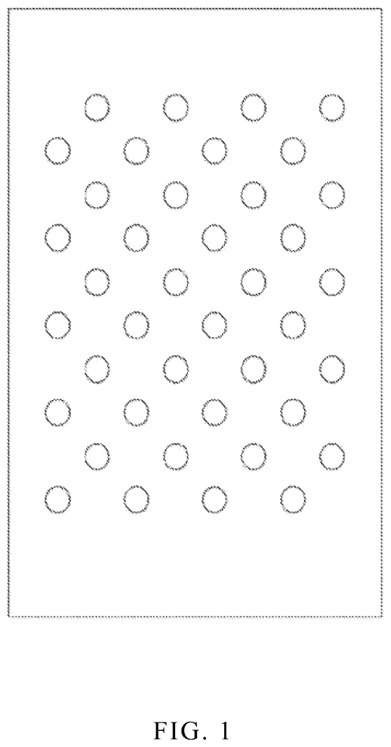

Referring to FIG. 1, in this embodiment, a three-dimensional high-precision fixed-point printing method is provided, which is executed by a printer.

The printer has 3 freedom degrees to move in an X-axis, a Y-axis and a Z-axis, and a plane of the printing platform is parallel to a plane of nozzles of an ink-jet printer

The method includes the following steps.

Step S1, printing, by a printer, a designated calibration pattern to a printing platform;
where the calibration pattern includes a checkerboard or a lattice diagram.

The printer prints when the z-axis coordinate is 0, and a starting position coordinate (x=0, y=0, z=0) of the printer is regarded as an origin of the printer coordinate system;

The calibration pattern is as shown in FIG. 1, which has a size of A6, and a total of 44 circles, and the relative coordinates of the centers of the circles are known. The coordinates of the points in the printer coordinate system are set as (xp1, yp1, zp1) to (xp44, yp44, zp44).

The coordinate of each center of a circle after printed is known in the printer coordinate system.

Step S2, obtaining, by photographing with a 3D camera, a two-dimensional picture (grayscale or color) and a 3D point cloud;
step S3, obtaining a conversion matrix of a printer coordinate system and a camera coordinate system (i.e. the external parameters of the 3D camera, which represent the rotational and translational relationship between the printer coordinate system and the camera coordinate system) at least based on the two-dimensional picture and the 3D point cloud;
where findCirclesGrid or SimpleBlobDetector detection of the opencv vision library may be used when finding the center of each circle on the 2d image. At the same time, there may be a point cloud of a pixel point on the corresponding pixel point. The coordinates in the camera coordinate system are (xc1, yc2, zc2) to (xc1, yc2, zc2); Since the point cloud of this point does not necessarily exist. Therefore, a threshold T=40 is set, and the number of centers of circles are detected as 0 to 44. For the accuracy of calibration, when the number of detected point cloud coordinates >T, the next calculation is carried out to obtain external parameters by solving pnp;

The projection equation of the three-dimensional high-precision fixed-point printing method can be expressed as follows:

$$λ [ \begin{matrix}u \\ v \\ 1\end{matrix} ] = K [ R t ] [ \begin{matrix}x \\ y \\ z \\ 1\end{matrix} ]$$

Where λ is the depth of the camera, (u, v) is the pixel coordinate and unit pixel, [u v 1] T is a homogeneous matrix, K is the camera internal parameter matrix, which is known; [R t] is external parameter of the camera, (x, y, z) is the coordinate point in the three-dimensional world, which has a unit in meter, and [x y z 1] T is a homogeneous matrix.

According to the external parameters, the point cloud in the camera coordinate system can be converted to the printer coordinate system.

After the 3D point cloud is converted to the printer coordinate system, each point cloud can be converted to the print plane.

The actual printed size of a picture is determined by the pixels and resolution of the picture. The pixel refers to the small color points that form the picture, and resolution (unit DPI) refers to the number of pixels per inch, which may be regarded as the distribution density of these small color points; When the pixels are the same, the higher the resolution, the greater the pixel density; the smaller the actual print size, and the more delicate the image.

Actual size (inches)=pixels/resolution; 1 inch=2.54 cm; for example, a picture is 600 pixels wide and has a resolution of 300, then the actual print width is: 600/300=2 inches, about 5 centimeters.

According to the above formula, the point cloud in the printer coordinate system can be converted to the pixel coordinate system of the picture (horizontally u and vertically v) without considering the z axis. Assuming that the coordinate of a point cloud is (25.4 mm, 250.4 mm, Z), then u=(25.4/25.4)*300=300, v=(250.4/25.4)=3000. Therefore the pixel coordinate of the point cloud is (300, 3000) in the picture coordinate system.

The factory calibration is to determine the conversion relationship between the 3D camera coordinate system and the printing coordinate system. The printer calibration method are as follows.

The above step S1 may include:
step S11, placing calibration paper for the printer (can be placed manually or by machine, and is not limited it the application);
step S12, moving to and stopping at a mechanical starting position by the printer;
step S13, photographing by the 3D camera, and identifying a position T1 of a carriage in a 3D coordinate system through mark points on a top of a printing carriage, where the T1 is a printing starting position;
step S14, printing specific patterns by the printer.

The above step S2 may include:
step S21, photographing by the 3D camera to identify a geometric center and a point cloud of pixel points of each printed pattern;
step S22, determining coordinates of each pattern in the camera coordinate system based on the identified geometric center and the identified point cloud of pixel points of each pattern.

By way of example and not limitation, the geometric center of each printed calibration pattern (e.g., when the calibration pattern is a circle, the geometric center is the center of the circle) may be sought on the 2D image obtained by camera photographing. At the same time, the point cloud of each calibration pattern in the 2D image can be found among the point clouds obtained by camera photographing. It will be appreciated that since a point cloud of a partial calibration pattern may not necessarily exist, a threshold value needs to be set for the accuracy of subsequent calibration operations. When the number of detected point clouds is greater than the threshold, the next step of calculating the external parameters can be performed. When the number of detected point clouds is less than the threshold, the calibration pattern is reprinted and photographed with a camera. The threshold may be a preset fraction of the number of printed calibration patterns. For example, when the calibration pattern includes 44 circles, the threshold may be set as 40. Of course, the number of calibration patterns and the threshold are not limited herein, and can be adjusted according to actual requirements. The calibration pattern may also be any other suitable pattern such as a checkerboard, which is not limited in any way in the present application.

The step S3 may include:
step S31, determining the conversion matrix between the printer coordinate system and the camera coordinate system based on coordinates of each pattern in the printer coordinate system and the camera coordinate system.

In some embodiments, for each height of a plurality of heights in a given height range, the steps S11 to S14, step S21, step S22 and step S31 may be performed to obtain the conversion matrix between the printer coordinate system and the camera coordinate system at the height.

During the nail decorating process,
1. the 3D camera takes pictures, and the coordinate B and a height H of the nail in the 3D camera coordinate system is obtained through a series of algorithms;
2. then convert the coordinate B into the coordinate C in the operating range coordinate system of the printer through the conversion matrix A corresponding to different heights H; and
3. send the coordinate C to the printer to execute the print job.

### Self-Check and Recalibration

In order to ensure the accurate positioning of each nail decorating operation, the system can carry out self-check according to the requirements, so as to find the positioning faults caused by various reasons.

Before the above step S11, following steps may be further included:
step S01, Moving to and stopping at a printing starting position by a printing carriage;
step S02, Photographing by the 3D camera, and identifying a position nT1 of a carriage in a 3D coordinate system through mark points on a top of a printing carriage;
step S03, Comparing a coordinate of nT1 with a coordinate of T1 recorded in a factory calibration, to determine whether a difference between the two exceeds a threshold;
step S041, performing maintenance actions when the difference between the two exceeds the threshold.

Through the above self-check operation, it can effectively prevent positioning errors caused by various reasons during nail decorating from causing damage to the user.

In some embodiments, the maintenance actions may include resetting the print carriage position. Additionally, the maintenance actions may include tightening components of the printer, cleaning flying ink, etc., which is not limited in any way in the application.

In some embodiments, the above method may further include:
step S042, performing the steps S01 to S03 again after performing the maintenance actions, and marking the printer as a failure state when the difference between nT1 and T1 is still larger than the threshold.

The printer marked as faulty can be returned to the factory for maintenance.

In some embodiments, the above method may further include:
step S042, performing the steps S11 to S14, S21, S22 and S31 when the difference between nT1 and T1 is less than the threshold.

As such, performing the calibration (e.g., performing again) after the self-check operation may ensure that the current camera external parameters are calibrated to the theoretical (e.g., when leaving the factory) external parameters of the camera.

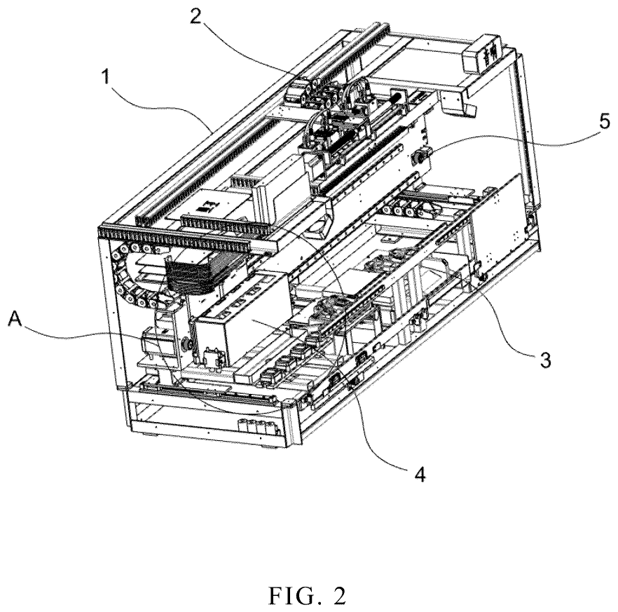

As shown in FIG. 2, this embodiment provides a three-dimensional high-precision fixed-point printing device, in which the printing mechanism performs printing through coordinate parameters provided by the computer vision mechanism 2, and the printing mechanism includes a rack 1, the rack 1 is installed with a computer vision mechanism 2, the computer vision mechanism 2 is arranged directly above the hand slot mechanism 3, and the computer vision mechanism 2 is composed of a camera, a structured light component, a vision control module, a light filling component and a moving module, where there are two cameras arranged on the left and right sides to take photos, while the structured light and light filling components assist the cameras in improving the accuracy of image capture. The computer vision mechanism 2 processes the captured photos through algorithms to calculate the point cloud information of the palm in a three-dimensional space. Based on the point cloud data, the height and the inclined angle of each finger are further calculated to enable the hand slot mechanism 3 to perform adjustments.

On the rack 1, a printing mechanism 4 is installed on the side of the computer vision mechanism 2, the printing mechanism 4 is connected to the X-axis moving module, Y-axis moving module, and Z-axis moving module, allowing movement in the X-axis, Y-axis, and Z-axis directions. The printing mechanism 4 includes a print nozzle module 401, which includes print nozzles and a housing. The print nozzles are connected to a material bin via an ink pathway, and the material bin is used for storing ink. A soft sensor 402 is installed on the side wall of the housing. The X-axis moving module includes a driving motor 403, which is connected to a driving wheel 404. The driving wheel 404 is connected to a driven wheel 5 via a transmission belt. The driven wheel 5 is installed at the other end of rack 1. When the driving motor 403 is activated, it drives the driving wheel 404 to rotate, and drives the driven wheel 5 to rotate via the transmission belt, enabling the print nozzle module 401 to move along the X-axis direction. The rear end of the print nozzle module 401 is connected to the Y-axis moving module, which is an elevating module. The Y-axis moving module enables the print nozzle module 401 to move up and down, to adjust the height of the print nozzle module 401. The structure formed by the combination of the X-axis moving module, Y-axis moving module, and print nozzle module 401 is connected to the Z-axis moving module 406. The Z-axis moving module 406 is a screw module, which, driven by a servo motor, drives the X-axis moving module, Y-axis moving module, and print nozzle module 401 to move forward and backward.

Furthermore, an ink absorbing assembly 7 is installed on the rack 1 below the printing mechanism 4. The ink absorbing assembly 7 includes an ink absorbing sponge and a sponge holder. The sponge holder is fixed to the rack 1, and the ink absorbing sponge remains moist. When the printing nozzle module 401 is not in use, the bottoms of the nozzles adhere to the ink absorbing sponge, keeping the nozzles in a moist state to prevent drying due to exposure to the environment. An ink receiving box 6 is installed on one side of the ink absorbing assembly 7, which has an opening at the top and a through hole at the bottom. Before the printing nozzle module 401 starts operation, it moves above the ink receiving box 6 under the drive of the Z-axis moving module 406. The Y-axis moving module 405 drives the printing nozzle module 401 to move downward, allowing the nozzles to enter the inside of the ink receiving box 6. The printing nozzle module 401 is activated to eject ink from the nozzles. Subsequently, the Y-axis moving module 405 is activated to lift the printing nozzle module 401. The driving motor 403 is activated to drive the driving wheel 404 and the driven wheel 5 to rotate, so that the printing nozzle module 401 moves above the hand slot mechanism 3 to perform printing to nails placed in the hand slot mechanism 3. After completing the printing operation, the X-axis moving module, Y-axis moving module 405, and Z-axis moving module 406 drive the printing nozzle module 401 back to its origin.

In the invention, the 3D coordinate can be converted to the printer coordinate system according to the printing requirement of the user, so as to accurately print to the target position, and the pattern can be flexibly printed on the object to be printed according to the actual position of the object to be printed without manual measurement and adjustment, thereby greatly improving speed and accuracy.

The embodiments are described for illustrative purposes only and are not intended to limit the present disclosure. Based on one or more embodiments in the present disclosure, all other embodiments obtained by those skilled in the art without creative operate fall within the scope of the present disclosure. Structures, devices, and methods of operation that are not specifically described and explained in the present invention are carried out according to conventional means in the art unless otherwise specified and limited.

What is claimed is:

1. A three-dimensional high-precision fixed-point printing method, wherein the method comprises the following steps:
step S1, printing, by a printer, a designated calibration pattern to a printing platform;
step S2, obtaining, by photographing with a 3D camera, a two-dimensional picture, and a 3D point cloud; and
step S3, obtaining a conversion matrix between a printer coordinate system and a camera coordinate system at least based on the two-dimensional picture and the 3D point cloud, as external references for the 3D camera.

2. The three-dimensional high-precision fixed-point printing method according to claim 1, wherein the step S1 comprises:
step S11, placing calibration paper for the printer;
step S12, moving the printer to a mechanical starting position and stopping the printer;
step S13, photographing by the 3D camera, and identifying a position T1 of a printing carriage in a 3D coordinate system through mark points on the top of a printing carriage, wherein the position T1 is a starting position for printing; and
step S14, printing specific patterns by the printer;
the step S2 comprises:
step S21, photographing by the 3D camera to identify a geometric center and a point cloud of pixel points of each printed pattern; and
step S22, determining coordinates of each pattern in the camera coordinate system based on the identified geometric center and the identified point cloud of pixel points of each pattern; and
the step S3 comprises:
step S31, determining the conversion matrix between the printer coordinate system and the camera coordinate system based on coordinates of each pattern in the printer coordinate system and the camera coordinate system.

3. The three-dimensional high-precision fixed-point printing method according to claim 2, characterized in that for each height of a plurality of heights in a given height range, the steps S11 to S14, step S21, step S22 and step S31 are performed to obtain the conversion matrix between the printer coordinate system and the camera coordinate system at the height.

4. The three-dimensional high-precision fixed-point printing method according to claim 2, wherein, before the step S11, the method further comprises:
step S01, moving the printing carriage to a printing starting position and stop the printing carriage;
step S02, photographing by the 3D camera, and identifying a position nT1 of a carriage in a 3D coordinate system through mark points on a top of a printing carriage;
step S03, comparing a coordinate of nT1 with a coordinate of T1 recorded in a factory calibration, to determine whether a difference between the two coordinates exceeds a threshold;
step S041, performing maintenance actions when the difference between the two exceeds the threshold.

5. The three-dimensional high-precision fixed-point printing method according to claim 4, wherein the maintenance actions comprise resetting a position of the printing carriage.

6. The three-dimensional high-precision fixed-point printing method according to claim 4, further comprising:
step S042, performing the steps S01 to S03 again after performing the maintenance actions, and marking the printer as a failure state when the difference between the coordinate of nT1 and the coordinate of T1 is still greater than the threshold.

7. The three-dimensional high-precision fixed-point printing method according to claim 4, further comprising:
step S042, performing the steps S11 to S14, S21, S22 and S31 when the difference between the coordinate of nT1 and the coordinate of T1 is less than the threshold.

8. The three-dimensional high-precision fixed-point printing method according to claim 1, characterized in that the printer has 3 free dimensions to move in an X-axis, a Y-axis and a Z-axis, and a plane of the printing platform is parallel to a plane of nozzles of an ink-jet printer.

9. The three-dimensional high-precision fixed-point printing method according to claim 1, characterized in that the calibration pattern in the step S1 comprises a checkerboard or a lattice diagram.

10. The three-dimensional high-precision fixed-point printing method according to claim 1, characterized in that, in the step S2, the printing is performed when the printer has a z-axis coordinate of 0, and a coordinate (x=0, y=0, z=0) of an starting position of the printer refers to an origin of the printer coordinate system.

11. A device adopting the three-dimensional high-precision fixed-point printing method according to claim 1, wherein the device comprises a rack, installed with a computer vision mechanism, a hand slot mechanism, and a printing mechanism, wherein the printing mechanism performs printing through coordinate parameters provided by the computer vision mechanism, and the computer vision mechanism is arranged directly above the hand slot mechanism.

12. The three-dimensional high-precision fixed-point printing device according to claim 11, wherein the computer vision mechanism comprises a camera, a structured light component, a vision control module, a light filling component and a moving module.

13. The three-dimensional high-precision fixed-point printing device according to claim 12, wherein the printing mechanism is connected with an X-axis moving module, a Y-axis moving module, and a Z-axis moving module, and the printing mechanism moves in an X-axis direction, a Y-axis direction, and a Z-axis direction.

14. The three-dimensional high-precision fixed-point printing device according to claim 13, wherein the X-axis moving module comprises a driving motor, wherein the driving motor is connected to a driving wheel, the driving wheel is connected to a driven wheel through a transmission belt, and the driven wheel is installed at another end of the rack.

15. The three-dimensional high-precision fixed-point printing device according to claim 14, wherein an ink absorbing assembly is installed on the rack below the printing mechanism, and the ink absorbing assembly comprises an ink absorbing sponge and a sponge holder, wherein the sponge holder is fixed to the rack.

16. The three-dimensional high-precision fixed-point printing device according to claim 15, wherein an ink receiving box is installed on one side of the ink absorbing assembly, an opening is provided at an upper part of the ink receiving box, and a through hole is provided at a bottom part of the ink receiving box.
